(19) United States
(12) Patent Application Publication
(10) Pub. No.: US 2025/0005897 A1
(43) Pub. Date: Jan. 2, 2025

(54) IMAGE PROCESSING FOR DISTINGUISHING PRODUCE-RELATED CHARACTERISTICS AT CHECKOUT

(71) Applicant: NCR Corporation, Atlanta, GA (US)

(72) Inventors: German Capuano, Tucker, GA (US); Noah Tyler Gardner, Dacula, GA (US); Kip Oliver Morgan, Atlanta, GA (US); Matthew K. Farrow, Canton, MA (US)

(21) Appl. No.: 18/217,315

(22) Filed: Jun. 30, 2023

(51) Int. Cl. G06V 10/764; G06Q 20/20; G06V 10/56; G06V 10/774; G06V 10/776; G06V 20/68

(52) U.S. Cl. CPC G06V 10/764; G06Q 20/201; G06Q 20/208; G06V 10/56; G06V 10/774; G06V 10/776; G06V 20/68

(57) ABSTRACT

At least one image of a produce item on a scale of a terminal is captured during a transaction at the terminal. A machine learning model provides a classification for the item based on the image. The classification indicates whether the item is bagged or unbagged. When the item is in a bag, a tare weight for the bag is subtracted from the weight recorded by the scale to calculate a price for the item. When the item is unbagged, the weight recorded by the scale is used to calculate the price. In an embodiment, the model provides a classification that indicates whether the item is organic or non-organic. When the item is organic, a transaction interface is automatically populated with an organic produce selection and presented to an operator of the terminal for confirmation.

### BACKGROUND

Self-checkout devices lack the capability to determine whether produce is in a bag or not in a bag. Regulations require that all produce transactions have their bag tare weights removed from the recorded weight of the produce unless a retailer has a means of determining whether the produce is in a bag or not in a bag.

Consequently, most checkouts remove bag tare weights from the recorded produce weight. A few retailers ask their customers whether produce on the scale is in a bag or not through the self-checkout's user interface. This decreases transaction throughput, worsens the user experience with the self-checkout, and is error prone. Furthermore, removing bag tare weights from all recorded produce sales means the retailer is underestimating the weight of the unbagged produce, leading to loss of revenue.

### SUMMARY

In various embodiments, a system and methods for distinguishing produce-related characteristics at checkout are presented. At least one image of a produce item on a scale of a terminal is captured during a transaction at the terminal. A machine learning model (“model”) provides a classification for the item based on the image. The classification indicates whether the item is in a bag or not in a bag. When the item is in a bag, a tare weight for the bag is subtracted from the weight recorded by the scale to calculate a price for the item. When the item is not in a bag, the weight recorded by the scale is used to calculate the price.

In an embodiment, the model provides a classification that indicates whether the item is organic or non-organic. When the item is organic, a transaction interface is automatically populated with an organic produce selection and presented to an operator of the terminal for confirmation.

### BRIEF DESCRIPTION OF THE DRAWINGS

FIG. 1A is a diagram of a system for distinguishing produce-related characteristics at checkout, according to an example embodiment.

FIG. 1B is flow diagram of a method for training a machine learning model to detect produce-related characteristics, according to an example embodiment.

FIG. 1C is a flow diagram of a method for detecting whether a produce item is in a bag or not in a bag, according to an example embodiment.

FIG. 1D is a flow diagram of a method for detecting whether a produce item includes an organic marker, according to an example embodiment.

FIG. 2 is a flow diagram of a method for distinguishing produce-related characteristics at checkout, according to an example embodiment.

FIG. 3 is a flow diagram of another method for distinguishing produce-related characteristics at checkout, according to an example embodiment.

### DETAILED DESCRIPTION

Purchasing produce at self-checkouts presents a variety of challenges for retailers. Government regulations require bag tare weights to be removed from the recorded produce weights unless the retailer can determine that the produce was not in a bag during the checkout. Most retailers elect to deduct the bag tare weights from every produce purchase that requires recorded weights regardless of whether the produce is actually bagged or not. A few retailers rely on the honesty of their customers to indicate whether a bag is being used or not. The expense associated with removing bag tare weights can be substantial for a retailer over time and/or across several stores of the retailers.

Another challenge for the retailers is detecting when a customer is purchasing organic produce. Organic produce is more expensive than non-organic produce. Customers may inadvertently or intentionally indicate their produce is non-organic when in fact it is organic. Produce sales that should have been priced for organic but are instead priced as non-organic result in significant shrink for retailers.

The teachings provided herein address these issues by providing an efficient and accurate technique for identifying whether produce is in a bag or not in a bag during a checkout. A machine learning model (hereinafter “model” and/or “MLM”) is trained based on a training dataset of images of bagged and non-bagged produce items to determine whether a given produce item during checkout is in a bag or not in a bag. When the item is in a bag, the predefined bag tare weight is subtracted from the recorded produce item's weight. When the item is not in a bag, the recorded produce item's weight is used for determining the price for the transaction.

Furthermore, in addition to the teachings provided herein for determining whether produce is bagged or unbagged, also disclosed herein are techniques for distinguishing during checkouts specific types of bags that are designated by retailers for organic produce. This allows for image-based detection of organic versus non-organic produce.

In an embodiment, the model or a separate model is trained to identify predefined markers within an image that are linked to organic produce. The markers may include, by way of example only, a specialized bag containing the produce, a dye stain on the produce, a specialized sticker on the produce, and/or a notation or other indicia applied to the produce. In an embodiment, the notation is a character or symbol generated by an infrared (IR) pen or marker, an ultraviolet pen or marker, and/or a visible spectrum pen or marker.

As used herein, the phrase “produce-related characteristic(s)” is intended to mean a produce item that is in a bag, not in a bag, includes an organic marker, and/or does not include an organic marker. The produce-related characteristic(s) is/are derived from at least one image that depicts the produce item placed on a scale during a transaction at a terminal. It is to be noted that the image can depict multiple produce items of the same produce type having a derived characteristic of being in a bag together, not being in a bag, having one or more organic markers present on one or more of the produce items, and/or not having any organic markers on any of the produce items.

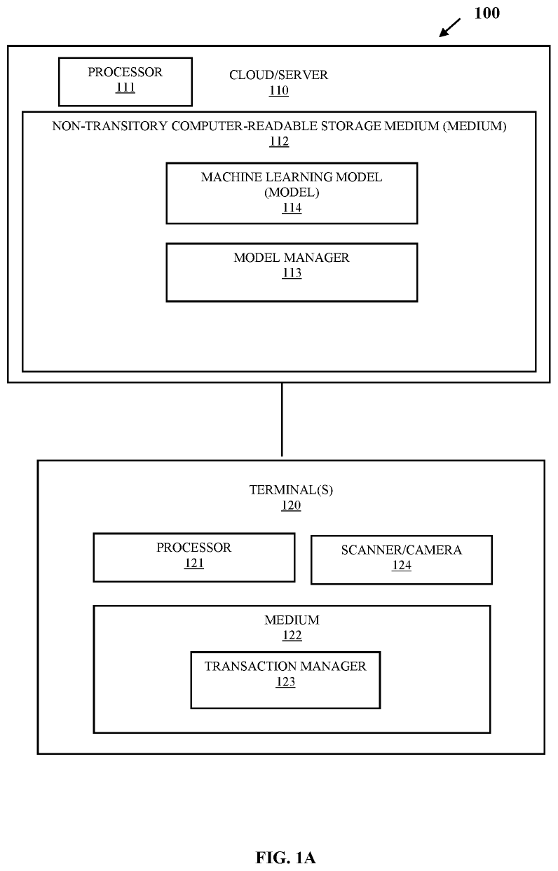

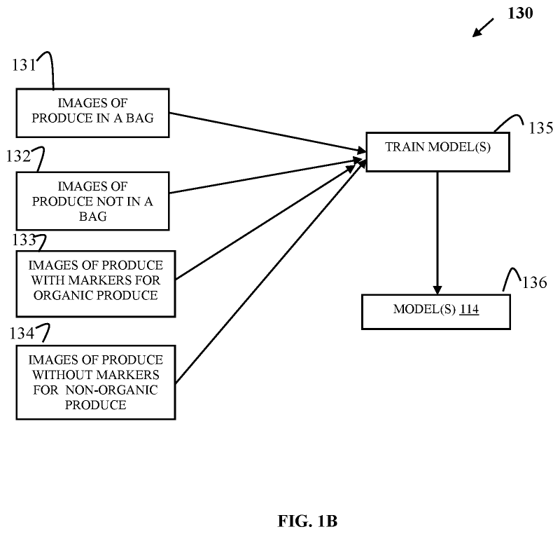

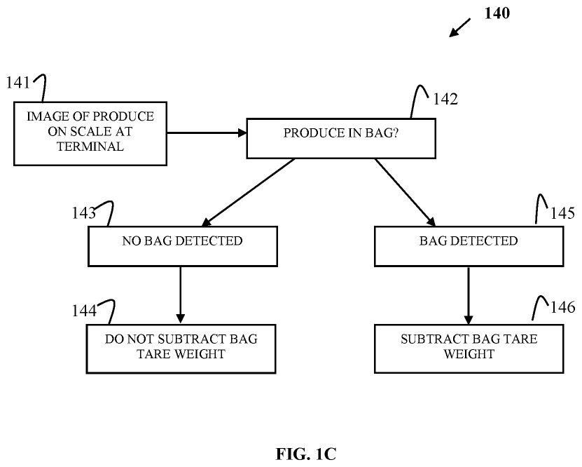

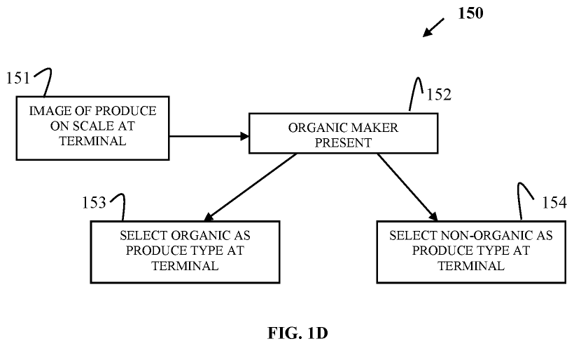

FIG. 1A is a diagram of a system 100 for distinguishing produce-related characteristics at checkout. It is to be noted that the components are shown schematically in greatly simplified form, with only those components relevant to understanding of the embodiments being illustrated.

Furthermore, the various components illustrated in FIG. 1A and their arrangement is presented for purposes of illustration only. It is to be noted that other arrangements with more or less components are possible without departing from the teachings of distinguishing produce-related characteristics for produce at checkout as presented herein and below.

The system includes a cloud 110 or a server 110 (hereinafter “cloud 110”) and a plurality of terminals 120. Cloud 110 includes a processor 111 and a non-transitory computer-readable storage medium (herein after just “medium”) 112, which includes executable instructions for a model manager 113 and a model 114.

Each terminal 120 includes a processor 121 and medium 112, which includes executable instructions for a transaction manager 123. Each terminal 120 further includes a scanner/camera 124 to capture at least one image of a produce item during a transaction at the corresponding terminal 120.

Initially, model 114 is trained on a training dataset that includes images of produce items that are in a bag and images of produce items that are not in a bag. Each image is labeled with an indication as to whether the image includes bagged produce or unbagged produce. The images are obtained from cameras 124, which capture produce placed on scales of terminal 120.

In an embodiment, model 114 or an additional model 114 is trained on images of produce items that include an organic produce marker and those that do not include any organic produce marker. The marker, when present, indicates that the associated produce item is an organic produce item, and its absence indicates the corresponding produce item is a non-organic produce item.

Following model training, model(s) 114 may be tested on additional images depicting produce items on scales of terminals 120 until an acceptable or predefined accuracy metric is achieved with the model(s) 114. In an example embodiment, a transaction workflow for transactions at terminals 120 is enhanced to provide images of produce items when operators of terminals 120 enter or select a price lookup (PLU) code corresponding to a produce item. Cameras 124 capture the images of the produce items while the produce items are on scales of the terminals 120 and the images are made accessible to model manager 113 via a network storage location and/or sent by transaction manager 123 to model manager 113.

For each transaction, model manager 113 provides the image of the produce item as input to model 114. Model 114 returns as output a classification indicating whether the produce item is bagged or not. In an embodiment, model manager 113 provides the image to a second model 114 as input to the second model 114. The second model 114 returns as output a classification indicating whether the produce item includes an organic marker or not. In an embodiment, model manager 113 provides the image as input to a single model 114. The single model 114 returns as output a first classification as to whether the produce item is in a bag or not and a second classification as to whether the produce item includes an organic marker or not. In an embodiment, model manager 113 simultaneously provides the image as input to both a first model 114 and a second model 114. The first model 114 returns as output a first classification as to whether the produce item is bagged or not. The second model 114 returns as output a second classification as to whether the produce item includes an organic marker or not.

Model manager 113 returns the classification(s) back to transaction manager 123. Based on a bag classification, transaction manager 123 determines whether a predefined bag tare weight should be subtracted from the weight recorded by the scale. When the bag classification indicates that a bag is detected, the tare weight is subtracted from the recorded weight. When the bag classification indicates that a bag is not detected, transaction manager 123 uses the full weight recorded by the scale to calculate the cost of the produce item. Based on any organic classification returned, transaction manager 123 selects organic produce within the transaction interface and presents the organic produce selection to the operator to confirm. If the operator overrides the organic selection of the transaction manager 123, transaction manager 123 performs preconfigured actions, such as accepting the operator override, suspending the transaction for an audit before the transaction is permitted to proceed, etc. In an embodiment, an operator override is identified as feedback data that causes transaction manager 123 to flag the produce item image and label it with the correct non-=organic produce classification for retraining of the model 114. In an embodiment, the model 114 is continuously retrained using images and feedback data that indicates that the images were incorrectly classified by the model 114.

In an embodiment, model manager 113 maintains metrics for model(s) 114 per retailer and/or per store for a plurality of stores of a given retailer based on terminal identifiers for terminals 120. The metrics are specific to the particular produce bags being used for produce by a particular retailer and/or at a particular store. For example, one retailer may use a produce bag that includes a low reflection material that results in model(s) 114 recognizing produce in the bag at a high confidence level. Another retailer may use a bag that is more reflective and that results in correspondingly lower confidence scores from model(s) 114. The metrics relevant to the image analysis of the bags used by the retailers and/or stores are analyzed to make recommendations to certain retailers and/or certain stores to change their produce bags in order to increase the confidence associated with the model(s)'s 114 output classification values.

In an embodiment, special organic produce bags are identified from the metrics. For example, model(s) 114 can be trained on images of organic produce placed in special bags having a green hue to distinguish between such bags and other detectable produce bags. In particular, model(s) 114 can be trained to identify and recognize a color profile of an image of bananas in a non-green bag and a color profile of an image of bananas in a green hue bag. The color profile of the green hue bag serves as an organic marker that results in the trained model(s) 114 classifying produce contained within such bags during transactions as organic produce. In an embodiment, model(s) 114 extracts a color profile from an image using a histogram (binning pixels of the image by color) and processes a comparison of green histogram values versus the average for bananas in regular or non-special organic produce bags.

In an embodiment, after a preconfigured number of transactions that include produce items, transaction manager 123 requests a given operator to indicate whether a given produce item being purchased is bagged or not. The corresponding image of the produce item and the operated-selected answer are flagged and provided to model manager 113. Model manager 113 uses the answers provided and the corresponding predicted classifications from the model(s) 114 to track performance of the model(s) 114 and/or retrain the model(s) 114. In this way, the model(s) 114 is monitored and retrained to improve its accuracy without the need for manual intervention.

In an embodiment, model(s) 114 are trained to identify other organic markers present on the produce both when the produce is bagged and unbagged. For example, model(s) 114 may be trained to identify a specialized sticker placed on organic produce items by store employees, other types of notations made on organic produce items, and/or the presence of a die or stain with which organic produce items have been at least partially coated. Example types of notations include predefined characters, symbols, lines, etc. In an embodiment, the notations are made with an IR or UV pen such that they are not visible to the human eye but are machine-detectable from the images using filters. In an embodiment, the die or stain is an edible special color die or wax in which a portion of the organic produce items are dipped or coated during item stocking. For example, tips of a bunch of organic bananas can be coated/dipped in a red die, thereby making them distinguishable from non-organic bananas.

In an embodiment, organic markers include special produce bags that are provided by a store to customers in the organic produce section. The customers place the organic produce items inside the bag at the organic produce section. In another embodiment, the organic makers are placed on the organic produce by store staff during stocking.

FIG. 1B is flow diagram of a method 130 for training a machine learning model to detect produce-related characteristics, according to an example embodiment. At 131, images of produce in a bag are obtained. At 132, images of produce that are not in a bag are obtained. At 133, images of produce that includes organic markers are obtained. At 134, images of produce that do not include organic markers are obtained.

Model manager 113 labels each image with the corresponding classification of bag, non-bag, organic, or non-organic. One or more models 114 are provided a training dataset of the labeled images as input during a training session. The model(s) 114 identify image factors and weights from each of the images and configure an algorithm based on the factors and weights to provide the labeled classification as output. The output from the model(s) 114 for a given image includes the classification and a confidence value associated with the classification, such as a percentage between 0 and 100.

FIG. 1C is a flow diagram of a method 140 for detecting whether a produce item is bagged or unbagged, according to an example embodiment. At 141, transaction manager 123 provides an image to model manager 113. The image depicts a produce item on a scale of terminal 120 during a transaction. Model manager 113 provides the image as input to model 114, based on which, model 114 returns a classification of the produce as bagged or unbagged at 142. Model manager provides the model-determined classification to transaction manager 123. When the classification is that no bag was detected at 143, transaction manager 123, at 144, calculates the price of the produce based on the weight provided by the scale and does not subtract a preconfigured bag tare weight from the weight recorded by the scale. When the classification is that a bag was detected at 145, transaction manager 123, at 146, calculates the price of the produce by subtracting a preconfigured bag tare weight from the scale provided weight.

FIG. 1D is a flow diagram of a method 150 for detecting whether a produce item includes an organic marker, according to an example embodiment. At 151, transaction manager 123 provides an image to model manager 113. The image depicts a produce item on a scale of terminal 120 during a transaction. Model manager 113 provides the image as input to model 114 at 152. Model 114 returns an organic or non-organic classification for the image and model manager 113 provides the classification back to transaction manager 123. When the classification is organic at 153, transaction manager 123 automatically selects an organic produce and displays the organic produce selection to the operator of terminal 120 during the transaction. When the classification is non-organic at 154, transaction manager 123 automatically selects non-organic produce and displays the non-organic produce selection to the operator during the transaction. In an embodiment, transaction manager 123 is configured to permit the operator of terminal 120 to override the automatically determined selection. In an embodiment, transaction manager 123 is configured to interrupt and suspend the transaction and request an audit when the operator overrides the automatically determined selection. In an embodiment, when an override of the selection is received, the corresponding image is flagged with the overridden classification and provided by transaction manager 123 to model manager 113 as dynamic feedback for use in re-training model(s) 114.

In an embodiment, a single image of the produce item is captured during a transaction and provided as input to model(s) 114 for classification. In an embodiment, multiple images captured by a single camera in multiple frames or captured by different cameras 120 at different angles are provided as input to model(s) 114. In this later embodiment, the model(s) 114 are trained on multiple images taken of the produce item to return the corresponding classification(s).

In an embodiment, terminal 120 is a self-service terminal (SST) that performs self-service transactions of customers who are the operators of the terminal 120. In an embodiment, terminal 120 is a point-of-sale (POS) terminal that performs cashier-assisted transactions for customers and which is operated by a cashier.

In an embodiment, model(s) 114 are also trained on the recorded weights provided by scales of the terminals 120. In this embodiment, transaction manager 123 provides both image(s) of the produce item as well as the corresponding recorded weight to model manager 113 during the transactions. In an embodiment, the weight of the produce item, depending upon the type of produce item, is used as one factor by model(s) 114 in distinguishing between organic and non-organic produce when no organic marker is detected. In an embodiment, a transaction history of the customer associated with the transaction is provided as input to model(s) 114 during transactions. In an embodiment, the transaction history is used as one factor by model(s) 113 in distinguishing between organic and non-organic produce when no organic maker is detected. For example, a customer who regularly purchases organic produce is more likely to be purchasing organic produce than a customer who only occasionally or rarely purchases organic produce.

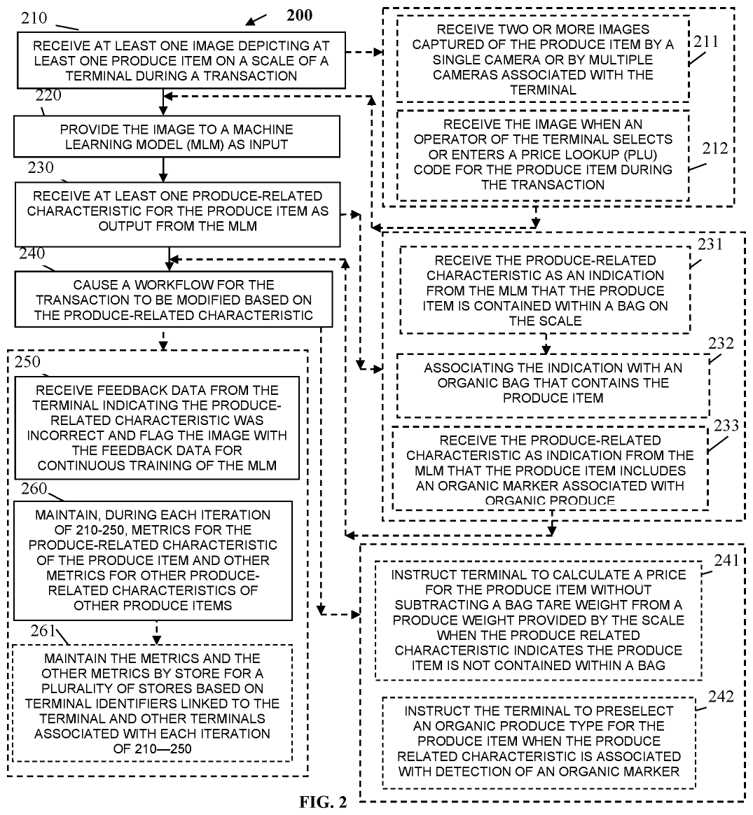

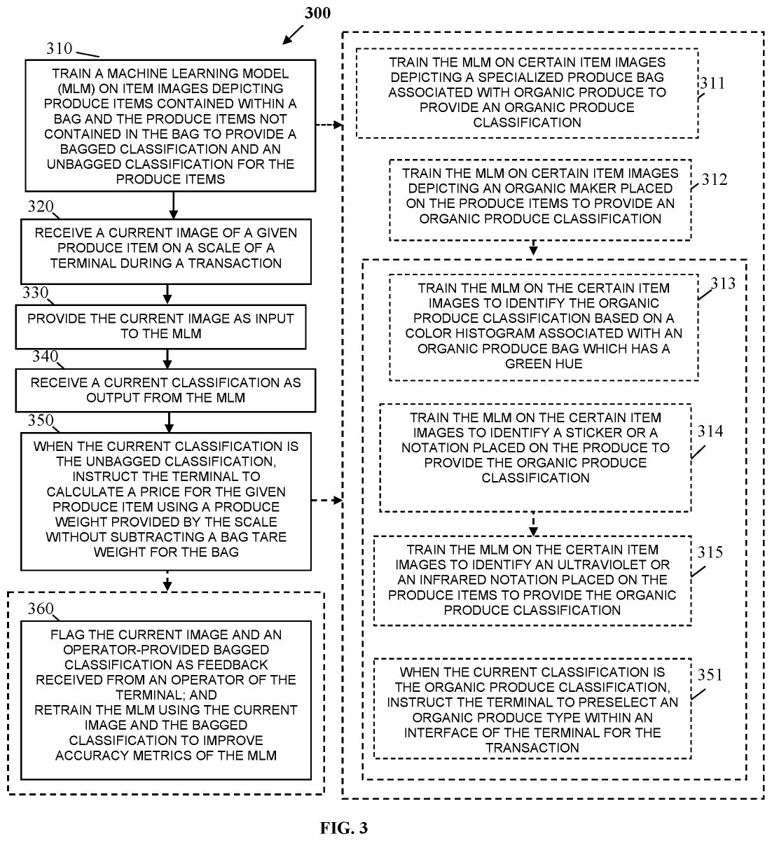

The above-referenced embodiments and other embodiments are now discussed with reference to FIGS. 2 and 3. FIG. 2 is a flow diagram of a method 200 for distinguishing produce-related characteristics at checkout, according to an example embodiment. The software module(s) that implements the method 200 is referred to as a “produce classifier.” The produce classifier is implemented as executable instructions programmed and residing within memory and/or a non-transitory computer-readable (processor-readable) storage medium and executed by one or more processors of one or more devices. The processor(s) of the device(s) that executes the produce classifier are specifically configured and programmed to process the produce classifier. The produce classifier has access to one or more network connections during its processing. The connections can be wired, wireless, or a combination thereof.

In an embodiment, the device that executes the produce classifier is cloud 110 or server 110. In an embodiment, server 110 is a server of a given retailer that manages multiple stores, each store having a plurality of terminals 120. In an embodiment, terminal 120 is an SST or a POS terminal. In an embodiment, the produce classifier is some, all, or any combination of, model manager 113 and/or model 114.

At 210, produce classifier receives at least one image depicting at least one produce item on a scale of a terminal 120 during a transaction. When there is more than one produce item, the produce items may be of a same type (e.g., several applies, tomatoes, a bunch of bananas, a bunch of asparagus, etc.).

In an embodiment, at 211, the produce classifier receives two or more images captured of the produce item by a single camera or by multiple cameras associated with the terminal. The multiple images captured by the single camera may correspond to different points in time within image frames of a video. In an embodiment, multiple cameras capture multiple images of the produce item at different angles. In an embodiment, a camera of a scanner captures the multiple images; for instance, the scale may be a combined scanner and scale integrated into the terminal 120 as a peripheral device.

In an embodiment, at 212, the produce classifier receives the image when an operator of the terminal selects or enters a price lookup (PLU) code for the produce item during the transaction. For example, a customer during a self-service transaction selects a PLU for the produce item within a user interface of transaction manager 123 or otherwise selects a PLU code associated with the produce item.

At 220, the produce classifier provides the image to a trained model 114. The model 114 is trained to provide at least one produce-related characteristic. The produce-related characteristic includes one or more classifications indicating whether the produce item is in a bag, not in a bag, and/or is or is not associated with organic produce.

At 230, the produce classifier receives the produce-related characteristic for the produce item as output from the model 114. In an embodiment, at 231, the produce classifier receives the produce-related characteristic as an indication from the model 114 that the produce item is contained within a bag on the scale. In an embodiment of 231 and at 232, the produce classifier associates the indication with a specialized organic produce bag that contains the produce item. In an embodiment, at 233, the produce classifier receives the produce-related characteristic as an indication from the model 114 that the produce item includes an organic maker which is associated with organic produce.

At 240, the produce classifier causes a workflow being processed by transaction manager 123 on terminal 120 to be modified and enhanced based on the produce-related characteristic. In an embodiment, at 241, the produce classifier instructs the transaction manager 123 of the terminal 120 to calculate a price for the produce item without subtracting a bag tare weight from a produce weight recorded or provided by the scale when the produce-related characteristic indicates the produce item is not contained within a bag. In an embodiment, at 242, the produce classifier instructs the transaction manager 123 of the terminal to preselect an organic produce type for the produce item when the produce-related characteristic is associated with detection of an organic marker.

In an embodiment, at 250, the produce classifier receives feedback data from the terminal 120. The feedback data indicates that the produce-related characteristic provided by the model 114 was incorrect. The produce classifier flags the image with the feedback data for continuous training of the model 114.

In an embodiment, at 260, the produce classifier maintains, during each iteration of 210-250, metrics for the produce-related characteristic of the produce item and other metrics for other produce-related characteristics of other produce items. In an embodiment of 260 and at 261, the produce classifier maintains the metrics and the other metrics on a per-store basis for a plurality of stores based on terminal identifiers linked to the terminal 120 and other terminals 120 associated with each iteration of 210-250. The metrics assist in identifying optimal produce bags by store, identifying specialized produce bags by store, and/or identifying organic markers for organic produce by store.

FIG. 3 is a flow diagram of a method 300 for distinguishing produce-related characteristics at checkout, according to an example embodiment. The software module(s) that implements the method 300 is referred to as a “produce characteristics classifier.” The produce characteristics classifier is implemented as executable instructions programmed and residing within memory and/or a non-transitory computer-readable (processor-readable) storage medium and executed by one or more processors of one or more devices. The processor(s) of the device(s) that executes the produce characteristics classifier are specifically configured and programmed to process the produce characteristics classifier. The produce characteristics classifier has access to one or more network connections during its processing. The connections can be wired, wireless, or a combination thereof.

In an embodiment, the device that executes the produce characteristics classifier is cloud 110 or server 110. In an embodiment, server 110 is a server of a given retailer that manages multiple stores, each store having a plurality of terminals 120. In an embodiment, terminal 120 is an SST or a POS terminal. In an embodiment, the produce characteristics classifier is some, all, or any combination of, model manager 113, model(s) 114, and/or method 200. In an embodiment, the produce characteristics classifier presents another, and in some ways, an enhanced processing perspective to that which was discussed above with respect to method 200 of FIG. 2.

At 310, produce characteristics classifier trains a model 114 on item images depicting produce items contained within a bag and images of produce items not contained in a bag. The model 114 is trained to provide as output a bagged classification or an unbagged classification for the produce items.

In an embodiment, at 311, the produce characteristics classifier trains the model 114 on certain item images depicting a specialized produce bag. The specialized bag is linked to or associated with organic produce. The produce characteristics classifier trains the model 114 to provide an organic produce classification as output for the certain item images.

In an embodiment, at 312, the produce characteristics classifier trains the model 114 on certain item images which depict an organic marker placed on the produce items. The produce characteristics classifier trains the model 114 to provide an organic produce classification when the organic marker is present.

In an embodiment of 312 and at 313, the produce characteristics classifier trains the model 114 on the certain item images to identify organic produce and output the organic produce classification based on a color histogram associated with an organic produce bag. For example, the organic produce bag may have a distinctive green hue color profile (or any other color profile) within the histogram.

In an embodiment of 312 and at 314, the produce characteristics classifier trains the model 114 on the certain item images to identify a sticker or a notation placed on the produce items and output the organic produce classification when such a notation or sticker is present in the image. In an embodiment of 314 and at 315, the produce characteristics classifier trains the model 114 to identify an UC or IR notation placed on the produce to provide the organic produce classification.

At 320, the produce characteristics classifier receives a current image of a given produce item on a scale of a terminal 120 during a transaction. At 330, the produce characteristics classifier provides the current image as input to the model 114. At 340, the produce characteristics classifier receives a current classification as output from the model 114.

At 350, when the current classification is the unbagged classification, the produce characteristics classifier instructs the terminal 120 to calculate a price for the given produce item using a produce weight provided by the scale without subtracting a bag tare weight for a bag. In an embodiment of 312 and 350, at 351, when the current classification is the organic produce classification, the produce characteristics classifier instructs the terminal 120 to pre-select an organic produce type within an interface of the terminal 120 for the transaction.

In an embodiment, at 360, the produce characteristics classifier flags the current image and an operator-provided bagged classification as feedback received from an operator of the terminal 120 when the current classification was predicted as the unbagged classification by the model 114 and overridden by the operator. The produce characteristics classifier retrains the model 114 using the current image and the operator-provided classification to improve accuracy metrics of the model 114. In this way, the produce characteristics classifier continuously trains the model 114 to improve the predicted classifications.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner. Furthermore, although the software modules are illustrated as executing on one piece of hardware, the software may be distributed over multiple processors or in any other convenient manner.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving at least one image depicting at least one produce item placed on a scale of a terminal during a transaction;
providing the at least one image to a machine learning model (MLM) as input;
receiving at least one produce-related characteristic for the at least one produce item as output from the MLM; and
causing a workflow for the transaction to be modified based on the at least one produce-related characteristic.

2. The method of claim 1 further comprising:
receiving feedback data from the terminal indicating that the at least one produce-related characteristic was incorrect; and
flagging the at least one image with the feedback data for continuous training of the MLM.

3. The method of claim 1 further comprising:
maintaining, during each iteration of the method, metrics associated with the at least one produce-related characteristic of the at least one produce item and other metrics for other produce-related characteristics of other produce items.

4. The method of claim 3 further comprising:
maintaining the metrics and the other metrics by store based on terminal identifiers linked to the terminal and other terminals associated with each iteration of the method.

5. The method of claim 1, wherein receiving the at least one image further includes receiving two or more images captured of the produce item by a single camera or by multiple cameras associated with the terminal.

6. The method of claim 1, receiving the at least one image further includes receiving the at least one image when an operator of the terminal selects or enters a price lookup (PLU) code for the at least one produce item during the transaction.

7. The method of claim 1, wherein receiving the at least one produce-related characteristic further includes receiving the at least one produce-related characteristic as an indication from the MLM that the at least one produce item is contained within a bag on the scale.

8. The method of claim 7, wherein receiving the at least one produce-related characteristic further includes associating the indication with a specialized bag for organic produce.

9. The method of claim 1, wherein receiving the at least one produce-related characteristic further includes receiving the at least one produce-related characteristic as an indication from the MLM that the at least one produce item includes an organic maker associated with organic produce.

10. The method of claim 1, wherein causing further includes one or more of:
instructing the terminal to calculate a price for the at least one produce item without subtracting a bag tare weight from a corresponding produce weight provided by the scale when the at least one produce-related characteristic is a classification of the at least one produce item as not being contained within a bag; and
instructing the terminal to pre-select an organic produce type for the at least one produce item when the at least one produce-related characteristic is a classification of the at least one produce item as being an organic produce item based on detection of an organic marker for the at least one produce item.

11. A method, comprising:
training a machine learning model (MLM) on a training dataset comprising first item images depicting first produce items contained within a bag and second item images depicting second produce items not contained in the bag to provide a bagged classification or an unbagged classification for each produce item;
receiving a current image of a given produce item on a scale of a terminal during a transaction;
providing the current image as input to the MLM;
receiving a current classification as output from the MLM;
when the current classification is associated with the unbagged classification, instructing the terminal to calculate a price for the given produce item using a produce weight provided by the scale without subtracting a bag tare weight for the bag.

12. The method of claim 11 further comprising:
flagging the current image and an operator-provided bagged classification as feedback received from an operator of the terminal; and
re-training the MLM using the current image and the operator-provided bagged classification to improve accuracy metrics of the MLM.

13. The method of claim 11, wherein training further includes training the MLM on certain item images depicting a specialized produce bag associated with organic produce to provide an organic produce classification.

14. The method of claim 11, wherein training further includes training the MLM on certain item images depicting an organic maker placed on the produce items to provide an organic produce classification.

15. The method of claim 14, wherein training further includes training the MLM on the certain item images to provide the organic produce classification based on a color histogram associated with an organic produce bag having a predefined color tint.

16. The method of claim 14, wherein training further includes training the MLM on the certain item images to provide the organic produce classification based on a sticker or a notation placed on the produce items.

17. The method of claim 16, wherein training further includes training the MLM on the certain item images to provide the organic produce classification based on an ultraviolet or an infrared notation placed on the produce items.

18. The method of claim 14, wherein when the current classification is the organic produce classification, instructing the terminal to preselect an organic produce type within an interface of the terminal for the transaction.

19. A system, comprising:
at least one server comprising at least one processor and a non-transitory computer-readable storage medium, the non-transitory computer-readable storage medium comprising executable instructions, that when executed by at least one processor cause the at least one processor to perform operations, comprising:
receiving, from a terminal, at least one image of at least one produce item placed on a scale of the terminal during a transaction in which a price lookup (PLU) code for the produce item was entered or selected at the terminal;
providing the at least one image to a machine learning model (MLM) as input;
receiving at least one produce-related characteristic for the at least one produce item as output from the MLM;
based on the at least one produce-related characteristic, instructing the terminal to one or more of:
determine a price for the at least one produce item by subtracting a bag tare weight from a produce weight provided by the scale for the at least one produce item when the at least one produce-related characteristic indicates a bagged classification for the at least one produce item or determine a price for the at least one produce item by not subtracting a bag tare weight from a produce weight provided by the scale for the at least one produce item when the at least one produce-related characteristic indicates an unbagged classification for the at least one produce item; or
preselect an organic produce type for the at least one produce item within an interface presented to an operator at the terminal when the at least one produce-related characteristic indicates a specialized produce bag classification or an organic marker classification.

20. The system of claim 19, wherein the terminal is a self-service terminal operated by a customer during the transaction or the transaction terminal is a point-of-sale terminal operated by a cashier during the transaction.
